(19) United States
(12) Patent Application Publication
(10) Pub. No.: US 2008/0024265 A1
(43) Pub. Date: Jan. 31, 2008

(54) Wrist-wearable electrical detection device

(76) Inventor: Richard K. Jones, Goodland, FL (US)

Correspondence Address: EDWARD M. LIVINGSTON, PA, 963 TRAIL TERRACE DRIVE, NAPLES, FL, 34103, US

(21) Appl. No.: 11/484,489

(22) Filed: Jul. 11, 2006

(51) Int. Cl. H01C 1/02

(52) U.S. Cl. 338/252

(57) ABSTRACT

A wrist-wearable detection device 2 for detecting a electrical potential of a pre-set magnitude within a certain proximity to the detection device. Detective circuitry 1 has a detection coil 3 that detects an electrical potential field generated by an electrically active field. The electrical potential is analyzed and compared by control circuit 20 against pre-set levels such as 60 Hz frequency, which in turn activates audible, visual (LED light) and for a vibratory indicator when in the presence of an electrical potential of a pre-set magnitude. The detector 2 is preferably incorporated into a wrist watch with controls (16, 17 and 18) which can be easily worn and thus always available for use.

### BACKGROUND OF THE INVENTION

This invention relates to electrical detection devices and more particularly to a wrist-worn voltage detector that may be incorporated with a standard watch.

When working in areas where there may be live electricity-conducting wires, such as electrical junction boxes and other devices, it is important for electricians and other workers, such as linemen, plumbers, firemen and even do-it-yourself persons, that one be able to quickly determine if a wire is live. Otherwise, an electrical shock may be received that could be damaging and even life-threatening. Currently, there are some sensors, such as one commonly referred to as a “clicker” which will warn of the presence of electricity, unfortunately such devices are typically separate tools and must be physically inserted into an electrical receptacle or against wires in order to determine whether the wires are live. Furthermore, such tools are often carried in a pocket or tool pouch and thus are not readily available when needed, are misplaced or are otherwise forgotten. Accordingly, electricians and others often take risks when working around electrical wires and appliances.

Thus, a need exists for a device that is readily available and wearable that can detect the presence of electricity, which provides one or more indicators and which can also be combined into a wrist watch, an accessory that is or can be worn by any worker.

The relevant prior art includes the following patents:

| Patent No. | | |
|---|---|---|
| (U.S. unless | | |
| stated otherwise) | Inventor | Issue Date |
| 3,068,409 | Bigliano, et al. | Dec. 11, 1962 |
| 3,471,784 | Arndt, et al. | Oct. 07, 1969 |
| 3,916,310 | Stark, et al. | Oct. 28, 1975 |
| 4,121,154 | Keating | Oct. 17, 1978 |
| 4,492,919 | Milkovic | Jan. 08, 1985 |
| 4,684,827 | Ohms | Aug. 04, 1987 |
| 4,719,414 | Miller, et al. | Jan. 12, 1988 |
| 5,583,436 | Van De Walle, et al. | Dec. 10, 1996 |
| 5,644,230 | Pant, et al. | Jul. 01, 1997 |
| 6,023,160 | Coburn | Feb. 08, 2000 |
| 6,529,114 | Bohlinger, et al. | Mar. 04, 2003 |

Although some of the prior art includes devices that detect the presence of electrical voltage or current, none do it in the manner taught by the present invention.

### SUMMARY OF THE INVENTION

The primary object of the present invention is to provide a device that will detect the presence of live electrical fields at a pre-determined distance from said fields.

Another object of the present invention is to provide such a device that can be incorporated into a common, wearable accessory, such as a wrist watch, so that it is readily available for use and is proximate the hands of a person working near electrical objects.

A further object of the present invention is to provide a detection device that provides one or more alarms, audible, visual, and/or physical, when the detector is proximate an electrical field.

The present invention fulfills the above and other objects by providing an electrical detection device for detecting the proximity of an electrical field, said device being preferably being worn on the wrist, wherein the device has circuitry for detecting an electrical potential generated by live electricity, with control circuitry for analyzing the magnitude of the field against a pre-set level and an indicator when the magnitude of the electrical field exceeds the pre-set level. The circuitry contains a detection coil for sensing the presence of an electrical field which is connected to an amplifier to amply the signal prior to sending it to the control circuitry. The control circuitry contains a comparative circuit for determining whether the electrical field has reached the pre-set level necessary to activate an indicator which may be an audible buzzer, a visible light or a physical indicator, such as vibration. The detector would preferably be incorporated into a wrist watch which is virtually an accessory of every worker so that it would be readily available as needed. The detector could have an adjustable detection range depending on the needs of a particular worker. The wrist band or watch band into which the detector is incorporated would be preferably a waterproof, high impact and heat resistant casing. The band could be colored or have colored markings so as to readily indicate to others that the detection device is being worn, a feature important to supervisors concerned about their workers' safety. The induction detector coil and the circuitry could be tuned to one or more electrical frequencies, such as sixty hertz (60 hZ) for United states, fifty hertz in Europe or other frequency in other parts of the world.

The detection device may have on/off buttons to activate the electrical indicator when a worker is aware of the presence of electricity. The detector alarm may be de-activated as desired once one has been made aware of the live electrical wires and must continue to work within the electrical field. However, once a worker moves away from the electrical field, the alarm would be automatically re-activated. The wrist band detector protection device of the present invention would include circuitry and a readable indication for the time or other various functions typical of watches.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a basic block diagram of the detection circuitry of the detection device of the present invention;

FIG. 2 is a perspective view of the detection device on a wrist of a worker in proximity to an electrical junction box containing live electrical wires;

FIG. 3 is a front view of a detection device incorporated into a protective watch casing; and

FIG. 4 is a schematic of the circuitry of the detection device incorporated with watch circuitry.

### DESCRIPTION OF THE PREFERRED EMBODIMENTS

For purposes of describing the preferred embodiment, the terminology used in reference to the numbered components in the drawings is as follows:

```
  1. Detection circuitry
  2. Electrical detector
  3. Detection means
  4. 60 Hz L.C. tank
  5. Local 1 kHz oscillator
  6. Power amplifier
  7. Audio amplifier
  8. LED light
  9. Speaker
10. Hand of user
11. Electrical junction box
12. Live electrical wiring
13. Electrical potential
14. Wrist band
15. Detector/watch face
16. Detector ON button
17. Detector OFF button
18. Watch control buttons
19. Detection circuit
20. Control circuit
21. Display LCD
22. Keypad
23. Buzzer alarm
24. Power
25. Backlight
26. Watch
```

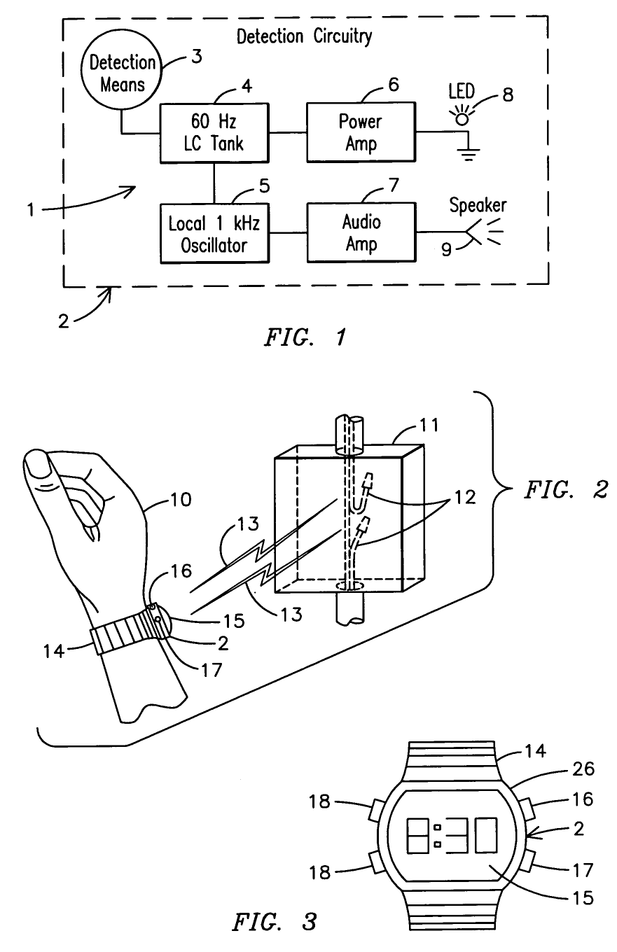

Referring now to the drawings, FIG. 1 illustrates block schematic form the basic detection circuitry 1 the detector 2 would utilize. A detection means such as a detection means 3, such as detection circuitry, antenna or other detection means, would be tuned to pick up a magnetic signal generated by an electric field of a pre-determined magnitude, in this case 60 Hz by the 60 hz LC tank 4. A power amp 6 would amplify the signal to activate an LED indicator 8 which will signal the presence of an electrical field of the pre-set pre-determined magnitude. In addition, a local 1 kHz oscillator 5 electrically connected to the 60 Hz LC tank 4 would activate an audio amp 7 that would drive a speaker 9 to emit also a noise signal warning the wearer of the presence of the electrical field. Although not shown one or more of the amplifiers 6 or 7 could be connected to a vibrating means, such as a pendulum, similar to that in a cell telephone, which would also be activated to vibrate, thereby physically providing indication to a wearer of the presence of an electrical potential having a pre-determined magnitude.

In FIG. 2 the detection device is shown incorporated into a watch on a wrist band 14 proximate a hand of a wearer 10 when near an electrical junction box 11 having live electrical wires 12 the detector 2 within a pre-set and pre-determined range of the electrical junction box 11, would pick up an electrical potential 13 generated by the live electrical wires 12. The detector 2 would then indicate the presence of an electrical field by emitting an alarm, a visual LED blinking light through the transparent face 15 or even vibratory means so as to warn the wearer 10 of the presence of the electrical field. A detector 2 could also have an on button 16 and an off button 17, to activate or de-activate the detector as desired.

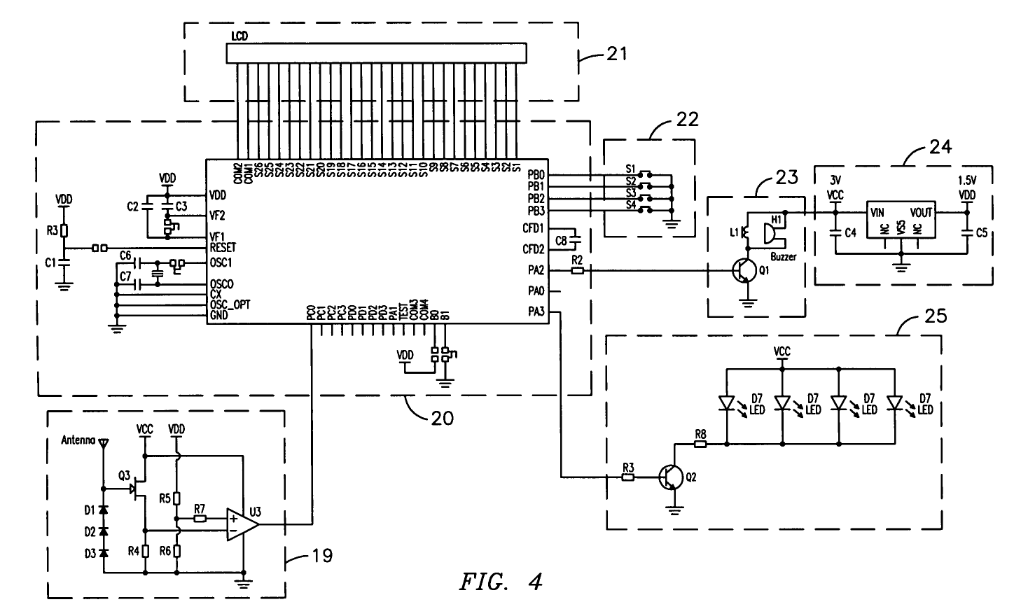

FIG. 3 shows the detector 2 incorporated into a watch 26 on a wrist band 14. The detector 2 in addition to containing detection circuitry would include watch circuitry to provide time and other features typical of a watch which could be activated by one or more control buttons 18. The watch 26 into which the detector 2 is incorporated would preferably be waterproof or water resistant, heat resistant and made of durable material such as rubber as is typical of many of the sports watches readily available and wearable by most workers who work in the presence of an electrical field.

In FIG. 4 the details for the embodiments of the detection circuitry of the preferred embodiment are illustrated. The detection circuit 19 detects an electrical potential generated by an electric field. The signal is amplified and provided to the control circuit 20 which analyzes it an compares it to a pre-set magnitude. If the signal is equal to or exceeds a pre-determined magnitude, then a backlight 25 is activated, which is visible through the display LCD 21 and an audible auditory alarm is also activated 23. The power for the detection device is provided for standard 1½ volt and 3 volt watch battery 24. The keypad 22 may be utilized to activate or deactivate the detection circuitry as desired and may be incorporated with another watch or other controls typical of a watch.

Although only a few embodiments of the present invention have been described in detail hereinabove, all improvements and modifications to this invention within the scope or equivalents of the claims are included as part of this invention.

Having thus described my invention, I claim:

1. An electrical detection device for detecting the proximity of a live electrical potential, said device comprising:
circuitry means for detecting an electrical potential generated by an electrical voltage in proximity to the device;
control circuitry means for analyzing a magnitude of the electrical potential against a pre-set level; and
indicator means for indicating when the electrical potential exceeds the pre-set level.

2. The detection device of claim 1 wherein the circuitry means for detecting an electrical potential comprises:
a detection coil for sensing the presence of an electrical potential which is electrically connected to an amplifier to amply the signal to activate an indicator that the electrical potential has exceeded the pre-set level.

3. The detection device of claim 1 wherein the control circuitry means comprises:
comparative circuitry for determining whether the electrical potential has reached the pre-set level necessary to activate the indicator means.

4. The detection device of claim 2 wherein the control circuitry means comprises:
comparative circuitry for determining whether the electrical potential has reached the pre-set level necessary to activate the indicator means.

5. The detection device of claim 1 wherein the indicator means comprises:
an audible buzzer.

6. The detection device of claim 2 wherein the indicator means comprises:
an audible buzzer.

7. The detection device of claim 3 wherein the I indicator means comprises:
an audible buzzer.

8. The detection device of claim 4 wherein the indicator means indicated means comprises:
an audible buzzer.

9. The detection device of claim 1 wherein the indicator means comprises:
a visible light.

10. The detection device of claim 2 wherein the indicator means comprises:
a visible light.

11. The detection device of claim 3 wherein the indicator means comprises
a visible light.

12. The detection device of claim 4 wherein the indicator means comprises:
a visible light.

13. The detection device of claim 5 wherein the indicator means comprises:
a visible light.

14. The detection device of claim 6 wherein the indicator means comprises:
a visible light.

15. The detection device of claim 7 wherein the indicator means comprises:
a visible light.

16. The detection device of claim 8 wherein the indicator means comprises:
a visible light.

17. The detection device of claim 1 wherein the indicator mans comprises:
a vibrator for physically indicating to the wearer the presence of an electrical potential.

18. The detection device of claim 1 wherein the detection device is attached to the wrist of a wearer by a wrist band.

19. The detection device of claim 18 wherein the detector is incorporated into a wrist watch.

20. The detection device of claim 1 further comprising:
one or more buttons for activating and e-activating the indicator means as desired.

21. The detection device of claim 18 wherein the detection device further comprises:
one or more buttons for activating and de-activating the indicator means as desired.

22. The detection device of claim 19 wherein the detection device further comprises:
one or more buttons for activating and de-activating the indicator means as desired.

23. The detection device of claim 18 further comprising:
a readily visible bright color on the wrist band to indicate to others that the detection device is being worn.

24. The detection device of claim 19 further comprising:
a readily visible bright color on the wrist band to indicate to others that the detection device is being worn.

25. The detection device of claim 1 further comprising:
a programmable means within the control circuitry for adjusting the range or distance from an electrical potential at which the indicator means is activated.
